(19) United States
(12) Patent Application Publication
(10) Pub. No.: US 2013/0031758 A1
(43) Pub. Date: Feb. 7, 2013

(54) FASTENING DEVICE

(71) Applicant: Peter J.H. CHANG, Taipei (TW)

(72) Inventor: Peter J.H. CHANG, Taipei (TW)

(73) Assignee: GOURMET EQUIPMENT (TAIWAN) CORPORATION, Taipei (TW)

(21) Appl. No.: 13/484,465

(22) Filed: May 31, 2012

(30) Foreign Application Priority Data
Aug. 3, 2011 (TW) 100214335

(51) Int. Cl. F16B 37/14; B25B 27/00

(52) U.S. Cl. 29/283; 411/429

(57) ABSTRACT

A fastening device is adapted for securing a wheel rim to a vehicle axle and is adapted to be driven rotatably by a driving tool. The fastening device includes a fastening member and a protection cap. The fastening member has a tool-engaging head portion and a first positioning portion. The protection cap has a cover portion and a sleeve portion that cooperates with the cover portion to cover the tool-engaging head portion and that is formed with a second positioning portion engaging removably the first positioning portion. When the protection cap is removed from the fastening member, the tool-engaging head portion of the fastening member is engageable with the driving tool.

### CROSS-REFERENCE TO RELATED APPLICATION

This application claims priority to Taiwanese Application No. 100214335, filed on Aug. 3, 2011.

### BACKGROUND OF THE INVENTION

1. Field of the Invention

The invention relates to a fastening device, and more particularly to a fastening device adapted for securing a vehicle wheel rim to a vehicle axle.

2. Description of the Related Art

A vehicle wheel rim is generally secured to a hub of a vehicle axle through a plurality of conventional bolt or nut fasteners. Each of the bolt or nut fasteners has a head that is disposed on the outside of the vehicle wheel rim and that is generally hexagonal or configured as a socket. The hexagonal-head type fastener can be driven rotatably by a driving tool such as a hexagonal wrench or a hexagonal socket wrench to be secured to or removed from the vehicle wheel rim. The head of the socket-head type fastener is formed with a plurality of grooves on a side surface thereof or formed with a non-circular aperture on a top surface thereof such that this type of fastener is driven to rotate by a complementary driving tool.

However, dust, mud or snow may accumulate on the exposed side or top surface of or in the grooves and aperture of the head of the conventional fastener, thereby resulting in damage to the conventional fastener and obstructing the engagement between the head of the conventional fastener and the driving tool.

### SUMMARY OF THE INVENTION

Therefore, the object of the present invention is to provide a fastening device that can overcome the aforesaid drawbacks of the prior art.

According to the present invention, a fastening device is adapted for securing a wheel rim to a vehicle axle and is adapted to be driven rotatably by a driving tool. The fastening device comprises a fastening member and a protection cap.

The fastening member extends along an axis and has a tool-engaging head portion that has opposite inner and outer ends along the axis, and a first positioning portion that is adjacent to the inner end of the tool-engaging head portion.

The protection cap has a cover portion that corresponds to the outer end of the tool-engaging head portion of the fastening member, and a sleeve portion that extends from a periphery of the cover portion along the axis, that cooperates with the cover portion to cover the tool-engaging head portion, and that is formed with a second positioning portion engaging removably the first positioning portion.

When the protection cap is removed from the fastening member, the tool-engaging head portion of the fastening member is engageable with the driving tool.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded perspective view of a vehicle axle, a wheel rim, a fastening member of a first preferred embodiment of a fastening device according to the present invention, and a driving tool;

FIG. 2 is an exploded perspective view showing the first preferred embodiment and a cap removing element;

FIG. 3 is a partly sectional view of the first preferred embodiment;

FIG. 4 is a front view of the cap removing element;

FIG. 5 is an exploded perspective view of a second preferred embodiment of the fastening device according to the present invention; and

FIG. 6 is a fragmentary partly sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

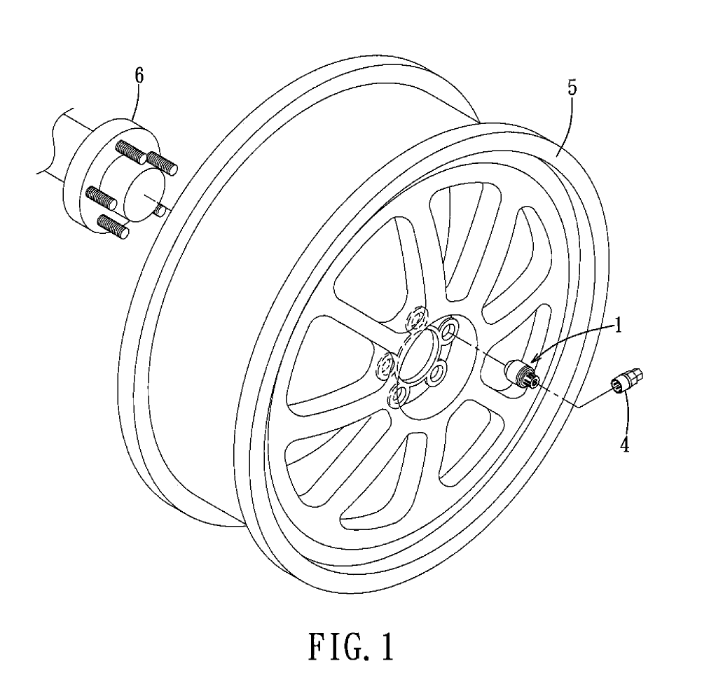

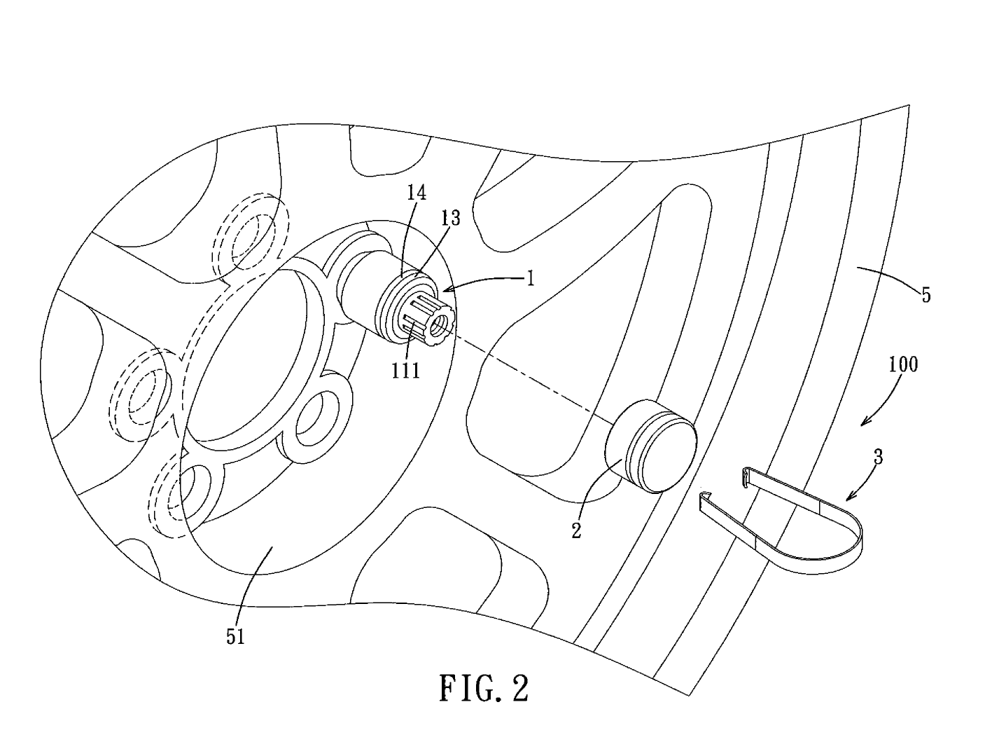

Referring to FIGS. 1 and 2, the first preferred embodiment of a fastening device 100 of the present invention includes a fastening member 1, a protection cap 2, and a cap removing element 3. In this embodiment, the fastening member 1 is configured as a nut secured threadedly to a threaded component that extends from a vehicle axle 6 through a wheel rim 5 at a hub recessed portion of the wheel rim 5 surrounded by a surrounding wall 51 for securing the wheel rim 5 to the vehicle axle 6.

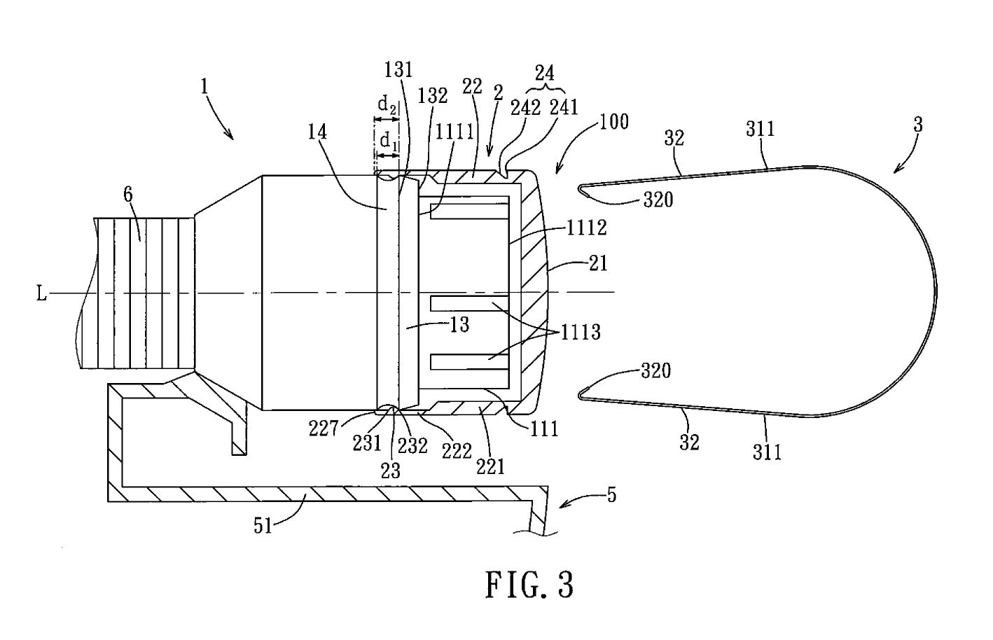

As further shown in FIG. 3, the fastening member 1 extends along an axis (L) and has a tool-engaging head portion 111, a guiding portion 13, and a first positioning portion 14.

The tool-engaging head portion 111 has opposite inner and outer ends 1111, 1112 along the axis (L), and is formed with a plurality of spaced apart grooves 1113 extending in the direction of the axis (L). In this embodiment, the first positioning portion 14 is adjacent to the inner end 1111 of the tool-engaging head portion 111. The guiding portion 13 has a first end 131 connected to the first positioning portion 19 and a second end 132 connected to the inner end 1111 of the tool-engaging head portion 111, and converges in dimensions from the first end 131 toward the second end 132.

The protection cap 2 has a cover portion 21 that corresponds to the outer end 1112 of the tool-engaging head portion 111 of the fastening member 1, and a sleeve portion 22 that extends from a periphery of the cover portion 21 along the axis (L). The sleeve portion 22 is formed with a second positioning portion 23 engaging removably the first positioning portion 14 of the fastening member 1, and has a distal end 227 spaced apart from the cover portion 21 along the axis (L). In this embodiment, the sleeve portion 22 is cylindrical and is further formed with a hook-engaging unit 24 that is configured as an annular groove in an outer surrounding surface and defined cooperatively by first and second groove-defining surfaces 241, 242. The first and second groove-defining surfaces 241, 242 are disposed respectively close to and away from the cover portion 21 of the protection cap 2 along the axis (L). The first groove-defining surface 241 is transverse to the axis (L) and the second groove-defining surface 242 is an inclined surface. The sleeve portion 22 has a base segment 221 extending from the periphery of the cover portion 21 along the axis (L), and an extending segment 222 extending from the cover portion 21 along the axis (L) with a thickness smaller than that of the base segment 221, having an inner surrounding surface that is opposite to the outer surrounding surface and formed with the second positioning portion 23, and formed with the distal end 227. When the second positioning portion 23 engages the first positioning portion 14, the sleeve portion 22 cooperates with the cover portion 21 to cover the tool-engaging head portion 111. The aforesaid thickness configuration of the sleeve portion 22 enhances the structural strength of the protection cap 2 when the protection cap 2 is coupled to and removed from the fastening member 1.

In this embodiment, the first positioning portion 14 of the fastening member 1 is configured as an annular groove, and the second positioning portion 23 of the protection cap 2 is configured as an annular protrusion. The first positioning portion 14 has a width (d₁) in the direction of the axis (L) smaller than that of the second positioning portion 23 and has a radius of curvature larger than a radius of curvature of the second positioning portion 23. The second positioning portion 23 of the protection cap 2 has an internal diameter smaller than an outer diameter of the first end 131 of the guiding portion 13 of the fastening member 1. During the engagement of the protection cap 2 with the fastening member 1, the second positioning portion 23 slides along the guiding portion 13 toward the first positioning portion 14 so that the sleeve portion 22 is radially and outwardly deformed, and that the internal diameter of the second positioning portion 23 is enlarged. When the second positioning portion 23 is moved to the first end 131 of the guiding portion 13, the internal diameter of the second positioning portion 23 is equal to the outer diameter of the first end 131 of the guiding portion 13. When the second positioning portion 23 is moved over the first end 131 of the guiding portion 13, the sleeve portion 22 is restored back to the original state by a restoring force thereof, thereby moving the second positioning portion 23 to engage the first positioning portion 14.

In this embodiment, the second positioning portion 23 of the protection cap 2 has a first side end 232 disposed on the inner surrounding surface of the extending segment 222 and spaced apart from the distal end 227 along the axis (L), and a second side end 231 on the inner surrounding surface and disposed between the first side end 232 and the distal end 227. A distance (d₂) between the distal end 227 and the first side end 232 of the second positioning portion 23 is larger than the width (d₁) of the first positioning portion 14. Therefore, the first positioning portion 14 can be completely covered by the sleeve portion 22.

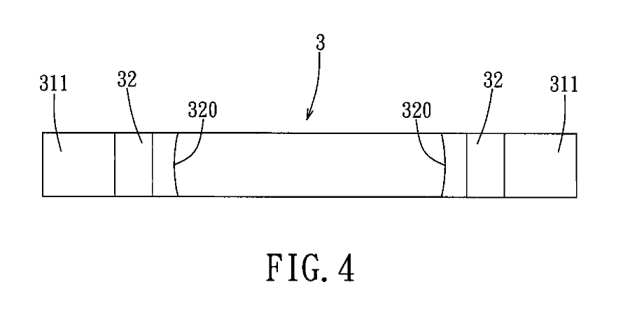

As further shown in FIG. 4, the cap removing element 3 has two arms 311. Each of the arms 311 has a hooked end portion 32 formed with a hook end 320 that corresponds in shape to a corresponding portion of the distal end 227 of the sleeve portion 22 of the protection cap 2. Specifically, the distal end 227 of the sleeve portion 22 of the protection cap 2 is annular, and the hook end 320 of the hook end portion 32 of each of the arms 311 is curved and has a radius of curvature equal to that of the distal end 227 of the sleeve portion 22 of the protection cap 2 (i.e., the hook end 320 of the hook end portion 32 of each of the arms 311 is configured to correspond in shape to a corresponding portion of the distal end 227).

When the protection cap 2 is coupled to the fastening member 1, the grooves 1113 of the head portion 111 and the first positioning portion 14 are protected from being covered with dust, mud, or snow. Moreover, since the tool-engaging head portion 111 is concealed within the protection cap 2, it cannot be easily seen from the outside. Therefore, it is troublesome for one with intent to steal the wheel rim 5 to find a driving tool that matches the tool-engaging head portion 111.

To remove the protection cap 2 from the fastening member 1, the two arms 311 of the cap removing element 3 are first outwardly and slightly biased, and the hook end 320 of the hooked end portion 32 of each of the arms 311 is moved to abut against the corresponding portion of the distal end 227 of the sleeve portion 22 of the protection cap 2. Consequently, a user can pull the cap removing element 3 along the axis (L) to remove the protection cap 2 from the fastening member 1. Afterward, a driving tool 4 (see FIG. 1), which has a hollow engaging head formed with a plurality of engaging protrusions that are engageable respectively with the grooves 1113, can be used to unfasten the fastening member 1 from the wheel rim 5 and the vehicle axle 6 with the engaging head being sleeved on the tool-engaging head portion 111 and the engaging protrusions engaging respectively the grooves 1113.

In some vehicle models, the hub recessed portion of the wheel 5 may be relatively small so that, during the removal of the protection cap 2, a space between the protection cap 2 and the surrounding wall 51 of the wheel rim 5 is insufficient for extension of the hooked end portions 320 of the arms 31 of the cap removing element 3 thereinto to engage the distal end 227 of the protection cap 2. By engaging the hook end 320 of the hooked end portion 32 of each of said arms 31 with the hook-engaging unit 24 such that the hook ends 320 of the arms 31 abuts against the first groove-defining surface 241, the user can pull the cap removing element 3 to remove the protection cap 2 from the fastening member 1.

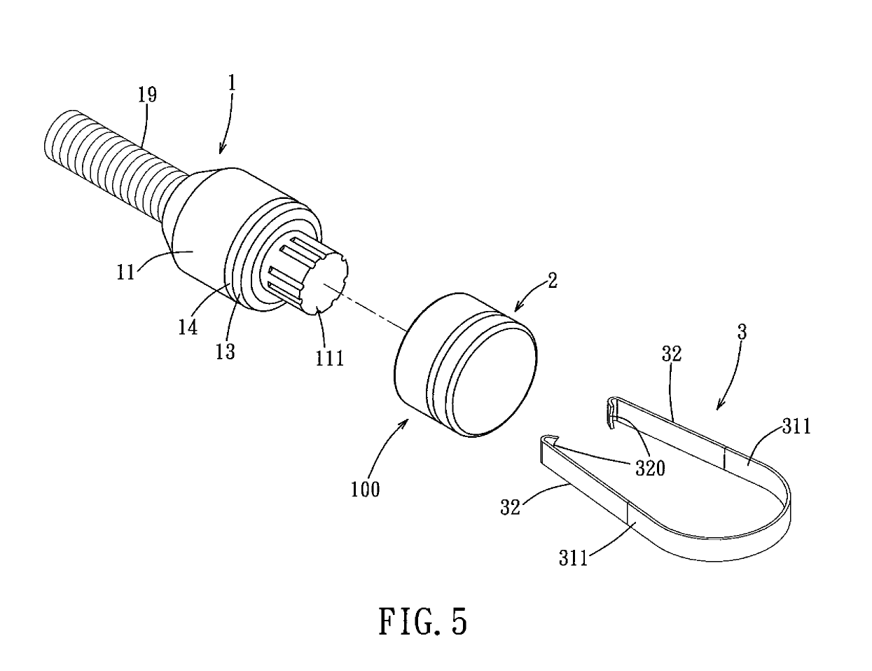

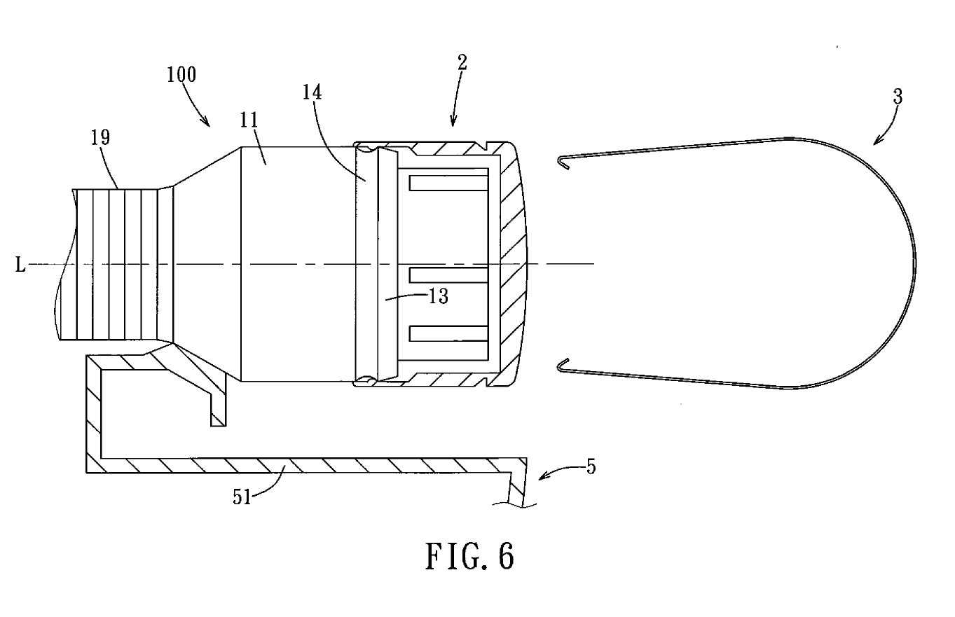

FIGS. 5 and 6 show a second preferred embodiment of the fastening device 100 according to this invention, which has a structure similar to that of the first preferred embodiment. In this embodiment, the fastening member 1 is configured as a bolt having a main body 11 and a threaded stem portion 19. The main body 11 is formed with the tool-engaging head portion 111, the guiding portion 13 and the first positioning portion 14. The threaded stem portion 19 extends from the main body 11 away from the tool-engaging head portion 111 along the axis (L), and can be operated to extend through the wheel rim 5 and engage threadedly the vehicle axle 6 for fastening the wheel rim 5 to the vehicle axle 6. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A fastening device adapted for securing a wheel rim to a vehicle axle and adapted to be driven rotatably by a driving tool, said fastening device comprising:
a fastening member extending along an axis and having
a tool-engaging head portion that has opposite inner and outer ends along the axis, and
a first positioning portion that is adjacent to said inner end of said tool-engaging head portion; and
a protection cap having
a cover portion that corresponds to said outer end of said tool-engaging head portion of said fastening member, and
a sleeve portion that extends from a periphery of said cover portion along the axis, that cooperates with said cover portion to cover said tool-engaging head portion, and that is formed with a second positioning portion engaging removably said first positioning portion;
wherein said tool-engaging head portion of said fastening member is engageable with the driving tool when said protection cap is removed from said fastening member.

2. The fastening device as claimed in claim 1, wherein said first positioning portion of said fastening member is configured as an annular groove, and said second positioning portion of said protection cap is configured as an annular protrusion having a width in a direction of the axis smaller than that of said first positioning portion.

3. The fastening device as claimed in claim 2, wherein:
said sleeve portion of said protection cap has a distal end spaced apart from said cover portion along the axis;
said second positioning portion of said protection cap protrudes from an inner surrounding surface of said sleeve portion, and has a first side end disposed on said inner surrounding surface and spaced apart from said distal end of said sleeve portion along the axis, and a second side end on said inner surrounding surface and disposed between said first side end and said distal end of said sleeve portion; and
a distance between said distal end of said sleeve portion and said first side end of said second positioning portion is larger than the width of said first positioning portion of said fastening member.

4. The fastening device as claimed in claim 2, wherein said first positioning portion has a radius of curvature larger than that of said second positioning portion.

5. The fastening device as claimed in claim 1, further comprising a cap removing element having two arms, wherein each of said arms has a hooked end portion formed with a hook end that corresponds in shape to a corresponding portion of said distal end of said sleeve portion of said protection cap.

6. The fastening device as claimed in claim 5, wherein:
said distal end of said sleeve portion of said protection cap is annular; and
said hook end of said hooked end portion of each of said arms is curved and has a radius of curvature equal to that of said distal end of said sleeve portion of said protection cap.

7. The fastening device as claimed in claim 1, wherein:
said fastening device further comprises a cap removing element for removing said protection cap, said cap removing element having two arms, each of said arms having a hooked end portion that is formed with a hook end; and
said sleeve portion of said protection cap is formed with a hook-engaging unit for being engaged with said hook end of said hooked end portion of each of said arms during removal of said protection cap.

8. The fastening device as claimed in claim 7, wherein: said hook-engaging unit is configured as an annular groove defined cooperatively by first and second groove-defining surfaces, said first and second grove-defining surfaces being disposed respectively close to and away from said cover portion of said protection cap along the axis, said first groove-defining surface being transverse to the axis for abutting against said hook end of said hooked end portion of each of said arms during the removal of said protection cap.

9. The fastening device as claimed in claim 5, wherein:
said fastening device further comprises a cap removing element for removing said protection cap, said cap removing element having two arms, each of said arms having a hooked end portion that is formed with a hook end; and
said sleeve portion of said protection cap is formed with a hook-engaging unit for being engaged with said hook end of said hooked end portion of each of said arms during removal of said protection cap.

10. The fastening device as claimed in claim 9, wherein: said hook-engaging unit is configured as an annular groove defined cooperatively by first and second groove-defining surfaces, said first and second grove-defining surfaces being disposed respectively close to and away from said cover portion of said protection cap along the axis, said first groove-defining surface being transverse to the axis for abutting against said hook end of said hooked end portion of each of said arms during the removal of said protection cap.

11. The fastening device as claimed in claim 1, wherein:
said fastening member further has a guiding portion that has a first end connected to said first positioning portion and a second end connected to said inner end of said tool-engaging head portion, and that converges in dimensions from said first end toward said second end; and
said second positioning portion of said protection cap has an internal diameter smaller than an outer diameter of said first end of said guiding portion of said fastening member.

12. The fastening device as claimed in claim 11, wherein said sleeve portion of said protection cap has:
a base segment extending from the periphery of said cover portion along the axis; and
an extending segment extending from said cover portion along the axis, having a thickness that is smaller than that of said base segment, and formed with said second positioning portion.
